(19) United States
(12) Patent Application Publication
(10) Pub. No.: US 2016/0004634 A1
(43) Pub. Date: Jan. 7, 2016

(54) INTERNAL STORAGE, EXTERNAL STORAGE CAPABLE OF COMMUNICATING WITH THE SAME, AND DATA PROCESSING SYSTEM INCLUDING THE STORAGES

(71) Applicant: Dong Min KIM, Hwaseong-si (KR)

(72) Inventor: Dong Min KIM, Hwaseong-si (KR)

(21) Appl. No.: 14/736,919

(22) Filed: Jun. 11, 2015

(30) Foreign Application Priority Data
Jul. 1, 2014 (KR) 10-2014-0082132

(51) Int. Cl. G06F 12/02; G06F 12/10; H04L 9/06; G06F 12/14

(52) U.S. Cl. CPC G06F 12/0246; G06F 12/1408; G06F 12/1009; H04L 9/06; G06F 2212/1052; G06F 2212/161; G06F 2212/2022; G06F 2212/402; G06F 2212/7201

(57) ABSTRACT

A memory controller, a data processing system, and an electronic device are provided. The memory controller is configured to share a function of one of an internal storage and an external storage in a union mode in which the external storage and the internal storage are logically unified with each other.

### CROSS-REFERENCE TO RELATED APPLICATION

This application claims priority under 35 U.S.C. §119(a) to Korean Patent Application No. 10-2014-0082132 filed on Jul. 1, 2014, the disclosure of which is hereby incorporated by reference in its entirety.

### BACKGROUND

1. Field

Exemplary embodiments relate to an internal storage, an external storage capable of communicating with the same, and a data processing system including the storages, and more particularly, to an internal storage for increasing data processing performance, an external storage capable of communicating with the same, and a data processing system including the storages.

2. Description of the Related Art

Portable electronic devices are gaining popularity and the level of consumers' demands is increasing. To meet the consumers' demands, portable electronic device weight has been reduced and portable device performance has been increased. However, there is a limit to increasing performance in terms of price and technology. In particular, there may be many restrictions when portable electronic devices are equipped with a high-capacity internal storage medium. Because an internal storage medium cannot be easily attached to or detached from a portable electronic device after being installed in the portable electronic device during mass production, the life of the internal storage medium may determine the life of the portable electronic device.

Recently, portable electronic devices have been developed to include a slot into which an external storage medium can be inserted to extend a storage space. However, an external storage medium does not usually provide any advantages except for simply extending a storage space. Moreover, when a portable electronic device includes both internal and external storages, the portable electronic device may be able to store data in the internal and external storages in a distributed fashion, but processes performed by the portable electronic device may be difficult to manage, such as managing mapping information for identifying distributed data. In addition, because the internal characteristics of the internal and external storages cannot be recognized, it may be difficult to perform optimum data input/output (I/O) operations to enhance the performance of the portable electronic device. Furthermore, when the portable electronic device is abruptly powered off or the external storage is suddenly detached, it may be difficult to restore data.

### SUMMARY

Certain aspects of the exemplary embodiments provide an internal storage for increasing management efficiency, data processing performance, and data reliability when an external storage is added, an external storage capable of communicating with the same, and a data processing system including the internal and external storages.

According to an aspect of an exemplary embodiment, there is provided a memory controller configured to share a function of one of an internal storage and an external storage in a union mode in which the external storage and the internal storage are logically unified with each other.

The memory controller may be configured to translate a logical address into a physical address based on a global mapping table which maps the logical address to the physical address of each of the internal storage and the external storage and may be further configured to determine which of the internal storage and the external storage processes data transmitted from a host.

In the union mode, the memory controller may be configured to control all data of a file to be stored in either the internal storage or the external storage according to control of the host.

The memory controller may be configured to store data in the internal storage and the external storage in a distributed fashion at a write request of the host.

In response to the memory controller receiving a request from the host to read data from the internal storage while the external storage is performing a write operation, the memory controller may be configured to perform a read operation to read the data from the internal storage to be performed.

The memory controller may be configured to collect feature information of the internal storage, may provide the feature information of the internal storage to the external storage, and may receive feature information of the external storage from the external storage.

The feature information of the internal storage and the feature information of the external storage may include hardware feature information indicating a characteristic about hardware of the internal storage and the external storage and software feature information indicating a characteristic of software of the internal storage and the external storage. The hardware feature information may include at least one among a capacity of non-volatile memory, a number of non-volatile memories, a number of channels in the non-volatile memory, a size of a user area, a size of a system area, a speed of a central processing unit (CPU), a capacity of random access memory (RAM), a speed of a physical layer (PHY), and inclusion or exclusion of an encryption module. The software feature information may include at least one among a version of a unified storage manager, a version of a flash translation layer (FTL), and a size of a mapping table.

The memory controller may be configured to communicate with the external storage using one of a standard protocol or a nonstandard protocol.

The function may be performed by a hardware component including a flash memory including a user area and a system area, and the memory controller may be configured to transmit data that is stored in the user area of the flash memory to the external storage to extend the system area of the flash memory. The extended system area may be used as a free block.

The function may be performed by a hardware component including an encryption engine configured to encode data stored in both of the internal storage and the external storage.

The function may be performed by a hardware component including a random access memory (RAM) configured to store a global mapping table which maps a logical address to a physical address of each of the internal storage and the external storage.

The memory controller may be configured to directly transmit data to the external storage.

The memory controller may be configured to transmit data to the external storage via the host.

The memory controller may be configured to transmit data to the external storage via an arbiter which is configured to relay the data.

The memory controller may be implemented in the internal storage.

The memory controller may be implemented in the external storage.

According to another aspect of an exemplary embodiment, there is provided a data processing system including an external storage provided external to an electronic device, an internal storage configured to be included in the electronic device, and a memory controller configured to share a function of one of the internal storage and the external storage in a union mode in which the external storage and the internal storage are logically unified with each other.

The function may be performed by a hardware component which may be one selected from an encryption engine, a random access memory (RAM), and a flash memory.

### BRIEF DESCRIPTION OF THE DRAWINGS

The above and other features and advantages will become more apparent by describing in detail exemplary embodiments thereof with reference to the attached drawings in which:

FIG. 1 is a block diagram of a data processing system according to an exemplary embodiment;

FIG. 2 is a block diagram of an example of the data processing system illustrated in FIG. 1;

FIG. 3 is a block diagram of another example of the data processing system illustrated in FIG. 1;

FIG. 4 is a block diagram of still another example of the data processing system illustrated in FIG. 1;

FIG. 5 is a flowchart provided to explain a union mode, in which an internal storage and an external storage illustrated in FIG. 1 are united, according to an exemplary embodiment;

FIG. 6 is a flowchart of a write operation in the union mode illustrated in FIG. 5;

FIG. 7 is a flowchart of a read operation in the union mode illustrated in FIG. 5; and

FIGS. 8, 9, 10, 11, 12 and 13 are conceptual diagrams for explaining the operations and features of the data processing system illustrated in FIG. 1.

### DETAILED DESCRIPTION OF THE EXEMPLARY EMBODIMENTS

The exemplary embodiments will now be described more fully hereinafter with reference to the accompanying drawings, in which certain exemplary embodiments are shown. The exemplary embodiments may, however, be embodied in many different forms and should not be construed as limited to the exemplary embodiments set forth herein. Rather, these exemplary embodiments are provided so that this disclosure will be thorough and complete, and will fully convey the scope of the exemplary embodiments to those skilled in the art. In the drawings, the size and relative sizes of layers and regions may be exaggerated for clarity. Like numbers refer to like elements throughout.

It will be understood that when an element is referred to as being “connected” or “coupled” to another element, the element can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the exemplary embodiments.

The terminology used herein is for the purpose of describing particular exemplary embodiments only and is not intended to be limiting of the exemplary embodiments. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the exemplary embodiments belong. It will be further understood that terms, such as those defined in commonly used dictionaries, should be interpreted as having a meaning that is consistent with their meaning in the context of the relevant art and/or the exemplary embodiments, and will not be interpreted in an idealized or overly formal sense unless expressly so defined herein.

The content disclosed in Joint Electron Devices Engineering Council (JEDEC) standard Universal Flash Storage (UFS) version 2.0, e.g., JESD220B published in September 2013 is hereby incorporated by reference. In addition, the standard specifications of mobile industry processor interface (MIPI) (e.g., M-PHY and UniPro specifications) are hereby incorporated by references. In detail, the MIPI alliance specification for M-PHYSM version 3.0 and the MIPI alliance specification for unified protocol (e.g., UniProSM) version 1.6 are hereby incorporated by references.

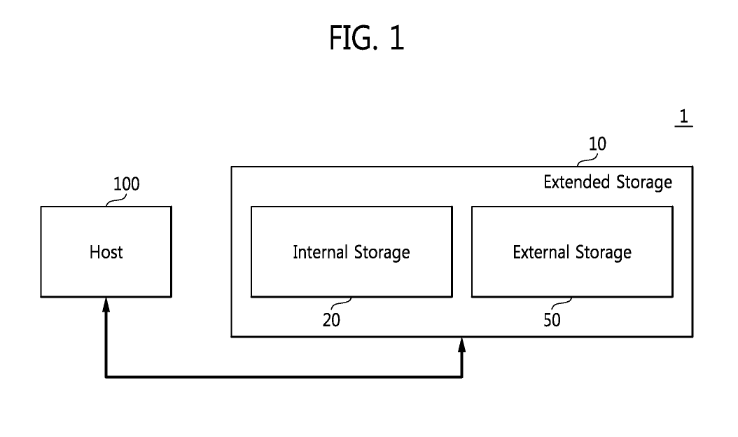

FIG. 1 is a block diagram of a data processing system 1 according to an exemplary embodiment. The data processing system 1 may include an extended storage 10 and a host 100. The data processing system 1 may be implemented as a smart phone, a tablet personal computer (PC), a camera, a personal digital assistant (PDA), a digital recorder, an MP3 player, an Internet tablet, a mobile Internet device (MID), a wearable computer, or an electronic toy.

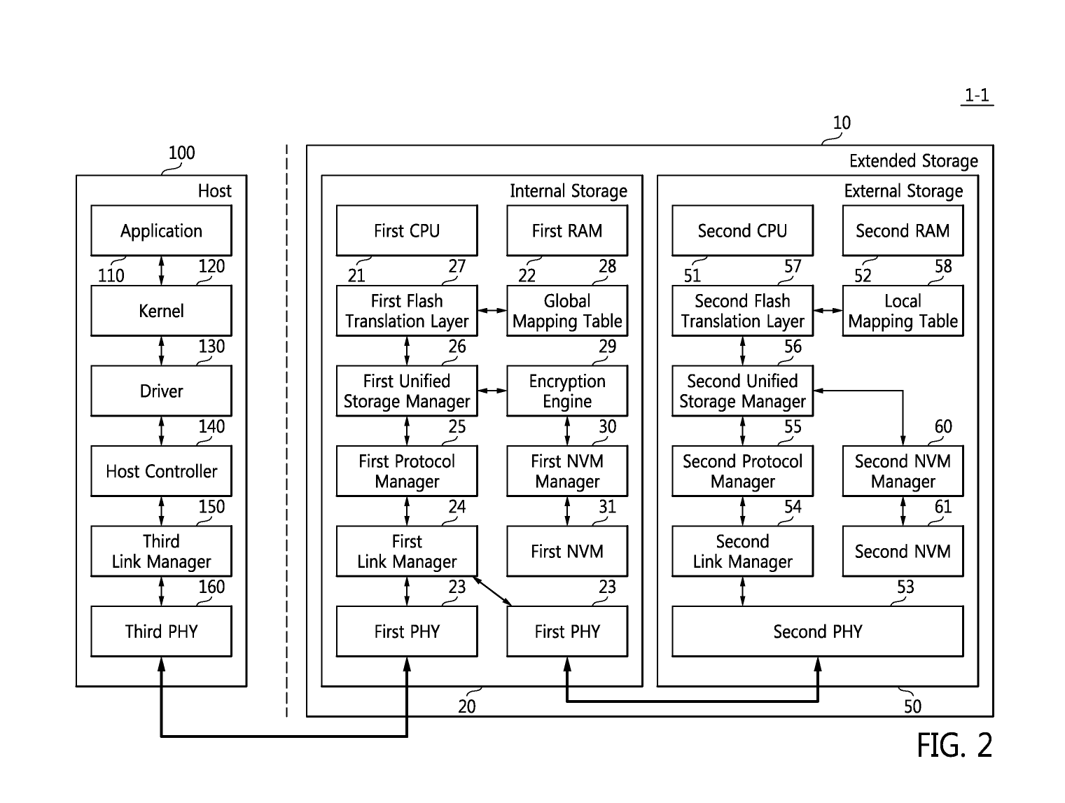

The extended storage 10 may communicate (e.g., exchange) various types of data (e.g., commands, read data, and write data) with the host 100. The extended storage 10 may include an internal storage 20 and an external storage 50. The internal storage 20 and the external storage 50 may include non-volatile memory that can store data. The structure of the internal storage 20 and the external storage 50 will be described in detail with reference to FIGS. 2 through 4. The extended storage 10 is a concept based on the assumption that the host 100 recognizes the internal storage 20 and the external storage 50 as a logically united single storage in union mode, which will be described later. Hereinafter, it is assumed that the operation of the extended storage 10 is performed in the union mode.

The host 100 may control the extended storage 10 included in the data processing system 1 and may be an application processor integrated circuit (IC). The host 100 may be implemented as a system on chip (SoC).

The host 100 may differently recognize the extended storage 10 according to a mode determined by a user's choice. In other words, the host 100 may recognize a storage outside the host 100 as a storage space (e.g., 32 gigabytes (GB)) identified by a logical address. The mode may be a union mode (or an extended mode) or a separation mode.

In the separation mode, the host 100 may recognize storages included in the extended storage 10 as separate storages that are logically independent from each other. In the union mode, the host 100 may recognize storages included in the extended storage 10 as a logically united single storage.

When it is assumed that the extended storage 10 includes the 8 GB internal storage 20 and the 32 GB external storage 50, the host 100 may recognize the 8 GB internal storage 20 and the 32 GB external storage 50 as logically independent storages in the separation mode. However, in the union mode, the host 100 may recognize the 8 GB internal storage 20 and the 32 GB external storage 50 as the extended storage 10 with 40 GB capacity.

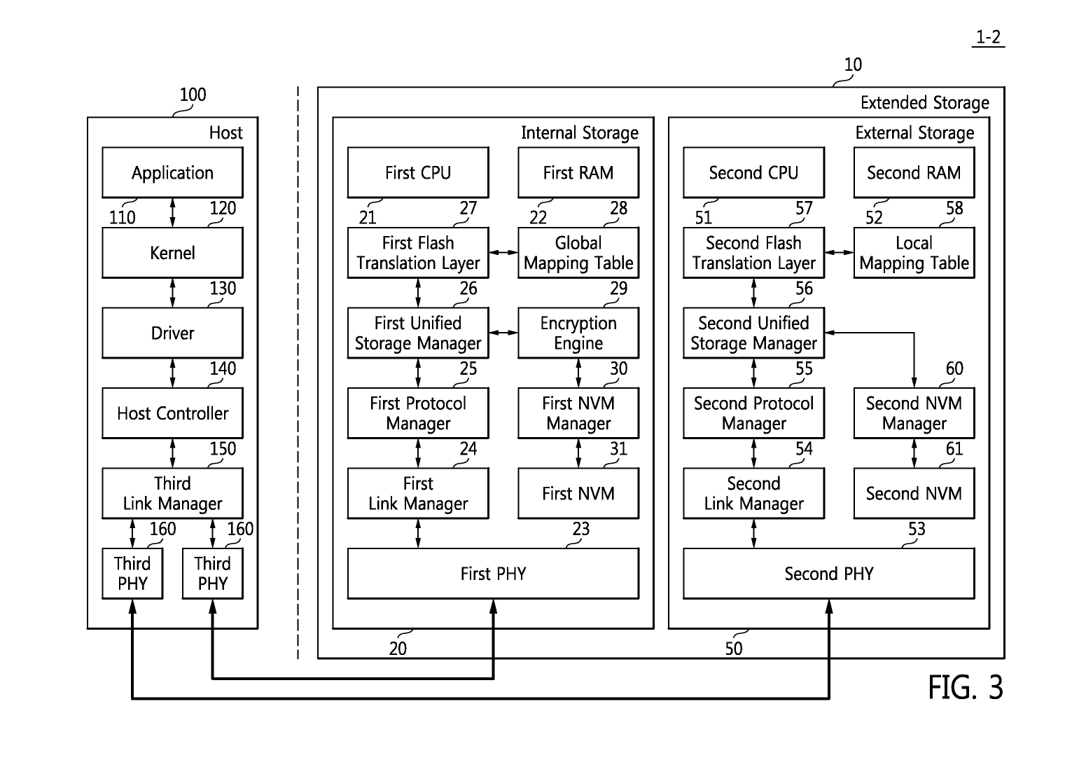

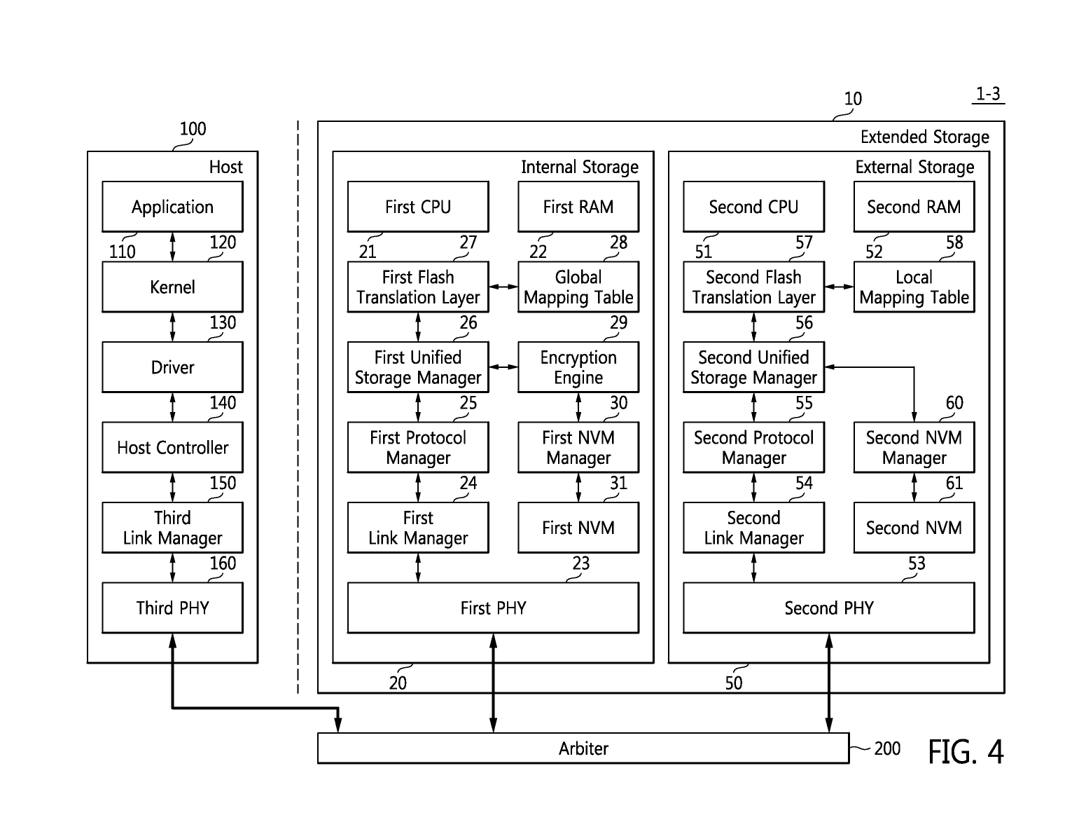

FIG. 2 is a block diagram of an example 1-1 of the data processing system 1 illustrated in FIG. 1. FIG. 3 is a block diagram of another example 1-2 of the data processing system 1 illustrated in FIG. 1. FIG. 4 is a block diagram of still another example 1-3 of the data processing system 1 illustrated in FIG. 1. Referring to FIGS. 1 through 4, the data processing systems 1-1 through 1-3 respectively illustrated in FIGS. 2 through 4 are different from one another in the connection of the elements 20, 50, and 100, but may have substantially the same components included in the elements 20, 50, and 100.

The data processing system 1-1 illustrated in FIG. 2 may include the internal storage 20, the external storage 50, and the host 100. The internal storage 20 may include a first central processing unit (CPU) 21, a first random access memory (RAM) 22, a first physical layer (PHY) 23, a first link manager 24, a first protocol manager 25, a first unified storage manager 26, a first flash translation layer (FTL) 27, a global mapping table 28, an encryption engine 29, a first non-volatile memory (NVM) manager 30, and a first NVM 31.

The first CPU 21 may process a program executed in the internal storage 20. The first RAM 22 may store the program and may be implemented as a volatile memory, e.g., a static RAM (SRAM). The first CPU 21 and the first RAM 22 may run firmware for operating the components 23 through 31 of the internal storage 20.

The first PHY 23 may communicate data with the host 100 and the external storage 50. The data may include a command, logical address information including information about the position (or logical address) and length of data recognized by the host 100, write data, and read data. The first PHY 23 may be implemented as a MIPI M-PHYSM. The first PHY 23 may include at least one lane. The at least one lane is a communication interface enabling data to be transferred to and from the host 100 or the external storage 50.

Referring to FIG. 2, the first PHY 23 may be made up of two first PHYs 23 that communicate data with the host 100 and the external storage 50, respectively. In detail, the first PHY 23 on the left may be connected to the host 100 and the first PHY 23 on the right may be connected to the external storage 50.

The first link manager 24 may control the flow of data that has been received from the first PHY 23 on the left and data to be transmitted to the first PHY 23 on the right. In detail, the first link manager 24 may identify a device identification (ID) included in data received from the first PHY 23 and may transfer the data to the first protocol manager 25 or return the data to the first PHY 23 according to the identification result. The first link manager 24 may also generate a device ID based on data received from the first protocol manager 25 and may transfer the data to one of lanes included in the first PHY 23 according to the device ID. Different device IDs may be allocated to the independent elements 20, 50, and 100, respectively. The first link manager 24 may be implemented as a MIPI UniPro.

The first protocol manager 25 may analyze a protocol of the data received from the first link manager 24 and transmit the data to the first unified storage manager 26. The first protocol manager 25 may also convert data received from the first unified storage manager 26 into a protocol that can be recognized by the element 50 or 100 and then transmit the data to the first link manager 24. A protocol that the first protocol manager 25 can analyze or convert may be a standard or nonstandard protocol.

The first protocol manager 25 may prioritize data that has been received and transmit the data according to the order of priority. The first protocol manager 25 may allocate priority to control-related data (e.g., data related to a mapping table) over management-related data (e.g., read data or write data).

The first unified storage manager 26 may determine whether data processing is performed by either or both of the internal storage 20 and the external storage 50. In detail, the first unified storage manager 26 may detect a state (e.g., a write operation, a read operation, existence or non-existence of storage space available, or existence or non-existence of read data) of the internal storage 20 and the external storage 50 based on physical address information provided from the first FTL 27 and a response from the external storage 50 and may make determinations about the data processing based on the state.

For instance, when the data includes a read command, the first unified storage manager 26 may transmit logical address information to the first FTL 27 and may determine which storage will execute the read command based on physical address information provided from the first FTL 27. The storage may be the internal storage 20 and/or the external storage 50.

When data to be read is stored in the internal storage 20, the first unified storage manager 26 may transmit the read command and the physical address information to the encryption engine 29. When the data to be read is stored in the external storage 50, the first unified storage manager 26 may transmit the read command and the physical address information to the first protocol manager 25. When the data to be read is stored in both the internal storage 20 and the external storage 50, the first unified storage manager 26 may separate the physical address information into two portions respectively corresponding to the internal storage 20 and the external storage 50, and transmit the two portions to the internal storage 20 and the external storage 50, respectively, together with the read command.

The first unified storage manager 26 may receive read data from the external storage 50 according to the read command and the physical address information and transmit the read data to the encryption engine 29. The physical address information may be information about the actual position (or a physical address) of data stored in the first NVM 31 of the internal storage 20 or in a second NVM 61 of the external storage 50 and the length of the data.

When the data includes a write command, the first unified storage manager 26 may transmit logical address information to the first FTL 27 and may determine which storage will execute the write command based on physical address information provided from the first FTL 27. The storage may be the internal storage 20 and/or the external storage 50.

When data is to be written to the internal storage 20, the first unified storage manager 26 may transmit the write command, write data, and the physical address information to the encryption engine 29. When the data is to be written to the external storage 50, the first unified storage manager 26 may transmit the write command, the write data, and the physical address information to the first protocol manager 25. When the data is to be written to both the internal storage 20 and the external storage 50, the first unified storage manager 26 may separate the physical address information and the write data into two portions respectively corresponding to the internal storage 20 and the external storage 50 and transmit the two portions of the physical address information and the two portions of the write data to the internal storage 20 and the external storage 50, respectively, together with the write command. In other exemplary embodiments, the first unified storage manager 26 may first transmit the write data to the encryption engine 29.

The first unified storage manager 26 may collect feature information of the internal storage 20 and may provide the feature information of the internal storage 20 for the external storage 50 or may be provided with feature information of the external storage 50 from the external storage 50. A second unified storage manager 56 may collect the feature information of the external storage 50 and provide the feature information of the external storage 50 for the internal storage 20 or may be provided with the feature information of the internal storage 20 from the internal storage 20.

Such a providing operation may be executed by the exchange of command and data between the internal storage 20 and the external storage 50. The feature information of the internal storage 20 provided for the external storage 50 may be stored in a memory 61 within the external storage 50 and the feature information of the external storage 50 provided for the internal storage 20 may be stored in the memory 31 within the internal storage 20.

The feature information of the internal storage 20 may have been stored in advance in the memory (e.g., the first NVM 31) within the internal storage 20. Similarly, the feature information of the external storage 50 may have been stored in advance in the memory (e.g., the second NVM 61) within the external storage 50. The feature information of the internal storage 20 and the feature information of the external storage 50 may include hardware feature information and software feature information.

The hardware feature information may include at least one item among the capacity of the NVM 31 or 61, the number of the NVM 31 or 61, the number of channels in the NVM 31 or 61, the size of a user area, the size of a system area, the speed of the CPU 21 or 51, the capacity of the RAM 22 or 52, the speed of the PHY 23 or 53, and inclusion or exclusion of the encryption engine 29. The software feature information may include at least one item among the version of the unified storage manager 26 or 56, the version of the FTL 27 or 57, and the size of the mapping table 28 or 58. It is understood, of course, that many other types of hardware feature information (e.g., information related to types or quantities of hardware components) and software feature information (e.g., information related to performance of software) may be used according to other exemplary embodiments.

The first or second unified storage manager 26 or 56 may use the feature information of the internal storage 20 and/or the feature information of the external storage 50 when the first or second unified storage manager 26 or 56 performs data processing.

The first FTL 27 may translate logical address information received from the first unified storage manager 26 into physical address information based on the global mapping table 28. For instance, when data received by the first unified storage manager 26 includes a read command, the first FTL 27 may determine physical address information corresponding to logical address information based on the global mapping table 28 and may transmit the physical address information to the first unified storage manager 26. When data received by the first unified storage manager 26 includes a write command, the first FTL 27 may determine physical address information for covering a size corresponding to logical address information based on the global mapping table 28 and may transmit the physical address information to the first unified storage manager 26.

The first FTL 27 may perform operations for management of the life of the first NVM 31 and maintenance of the first NVM 31. In detail, the first FTL 27 may determine whether to write data to a cell in the first NVM 31 based on a number of activations to the cell for writing and whether to move data that has been stored.

The global mapping table 28 may store mapping information between logical addresses and physical addresses. The global mapping table 28 may also store information about whether data has been stored at each physical address. The global mapping table 28 may be updated every time when an erase operation or a write operation is performed in either of the first and second NVMs 31 and 61.

According to exemplary embodiments, the global mapping table 28 may be stored in the first NVM 31, the first RAM 22, or the second RAM 52. For instance, when the internal storage 20 does not have sufficient space for the global mapping table 28, the whole or part of the global mapping table 28 may be stored in the second RAM 52. At this time, the whole or part of the global mapping table 28, which has been stored in the second RAM 52, may be shared through communication between the first FTL 27 and the second FTL 57.

The encryption engine 29 may encode data (e.g., a write command, write data, and physical address information) received from the first unified storage manager 26. The encryption engine 29 may also decode data received from the first NVM manager 30.

According to exemplary embodiments, the encryption engine 29 may encode write data to be written to the external storage 50 according to the control of the first unified storage manager 26 or may decode read data read from the external storage 50 and transmit the read data to the first unified storage manager 26.

The first NVM manager 30 may manage the first NVM 31 and may write the encoded data to the first NVM 31 or read data from the first NVM 31. The first NVM manager 30 may be a memory controller.

The first NVM 31 may store or output data according to the control of the first NVM manager 30. The first NVM 31 may be implemented as a NAND flash memory, a NOR flash memory, a resistance RAM (RRAM), or a phase-change RAM (PRAM).

The external storage 50 may include the second CPU 51, the second RAM 52, the second PHY 53, a second link manager 54, a second protocol manager 55, the second unified storage manager 56, the second FTL 57, a local mapping table 58, a second NVM manager 60, and the second NVM 61. The functions and operations of the second CPU 51, the second RAM 52, the second PHY 53, the second link manager 54, the second protocol manager 55, and the second NVM 61 are substantially the same as those of the first CPU 21, the first RAM 22, the first PHY 23, the first link manager 24, the first protocol manager 25, and the first NVM 31 included in the internal storage 20.

The second unified storage manager 56 may perform an operation according to data received from the second protocol manager 55. For instance, when the data includes a read command and physical address information, the second unified storage manager 56 may transmit the read command and the physical address information to the second NVM manager 60. When the data includes a write command, write data, and physical address information, the second unified storage manager 56 may transmit the write command, the write data, and the physical address information to the second NVM manager 60.

The second FTL 57 may translate logical address information received from the second unified storage manager 56 into physical address information based on the local mapping table 58 in the separation mode. The translation of logical information address by the second FTL 57 may be substantially the same as the translation of logical information by the first FTL 27. According to exemplary embodiments, the second FTL 57 may translate logical address information into physical address information and provide the physical address information for the internal storage 20 even in the union mode (e.g., when the whole or part of the global mapping table 28 is stored in the second RAM 52 due to the deficiency of storage space in the internal storage 20). The second FTL 57 may also perform operations for management of the life of the second NVM 61 and maintenance of the second NVM 61.

The local mapping table 58 may store mapping information between logical addresses and physical addresses of the second NVM 61. The local mapping table 58 may also store information about whether data has been stored at each of the physical addresses.

The second NVM manager 60 may manage the second NVM 61 and may write data received from the second unified storage manager 56 to the second NVM 61 or read data from the second NVM 61. The second NVM manager 60 may be a memory controller.

The host 100 may include an application 110, a kernel 120, a driver 130, a host controller 140, a third link manager 150, and a third PHY 160. The application 110 may processes a user's command and may send a request corresponding to the command to the kernel 120. The application 110 may be a group of applications (e.g., a device unification management application, a music player application, and a video player application).

The kernel 120 may convert a request from the application 110 into a function that can be recognized by the driver 130 and may transmit the function to the driver 130. The kernel 120 may be an operating system (OS) in other exemplary embodiments.

The driver 130 may convert the function into data in a format that can be recognized by the storage 20 or 50 to which data will be transmitted at the user's request. When the storage 20 or 50 is a UFS, the driver 130 may convert the function into UFS protocol information units.

The host controller 140 may transmit data from the driver 130 to the third link manager 150 or may interpret data received from the third link manager 150 and transmit the interpreted data to the driver 130.

The functions and operations of the third link manager 150 and the third PHY 160 may be substantially the same as those of the first link manager 24 and the first PHY 23.

The data processing system 1-1 illustrated in FIG. 2 has a structure in which the internal storage 20 is connected to the host 100 and the external storage 50. In this case, data transmission between the host 100 and the external storage 50 may be performed via the first PHY 23 and the first link manager 24 of the internal storage 20.

The data processing system 1-2 illustrated in FIG. 3 has a structure in which the host 100 is connected to the internal storage 20 and the external storage 50. In this case, data transmission between the internal storage 20 and the external storage 50 may be performed via the third PHY 160 and the third link manager 150 of the host 100. In the exemplary embodiments illustrated in FIG. 3, the third PHY 160 may be made up of two third PHYs 160 that communicate data with the internal storage 20 and the external storage 50, respectively. In detail, the third PHY 160 on the left may be connected to the internal storage 20 and the third PHY 160 on the right may be connected to the external storage 50.

The data processing system 1-3 illustrated in FIG. 4 may further include an arbiter 200. The data processing system 1-3 has a structure in which the host 100, the internal storage 20, and the external storage 50 are all connected to the arbiter 200

In this case, data transmission among the host 100, the internal storage 20, and the external storage 50 may be performed via the arbiter 200. In detail, the arbiter 200 may identify a device ID for data received from the host 100, the internal storage 20, or the external storage 50 and may transmit the data to one among the host 100, the internal storage 20, and the external storage 50 according to the device ID.

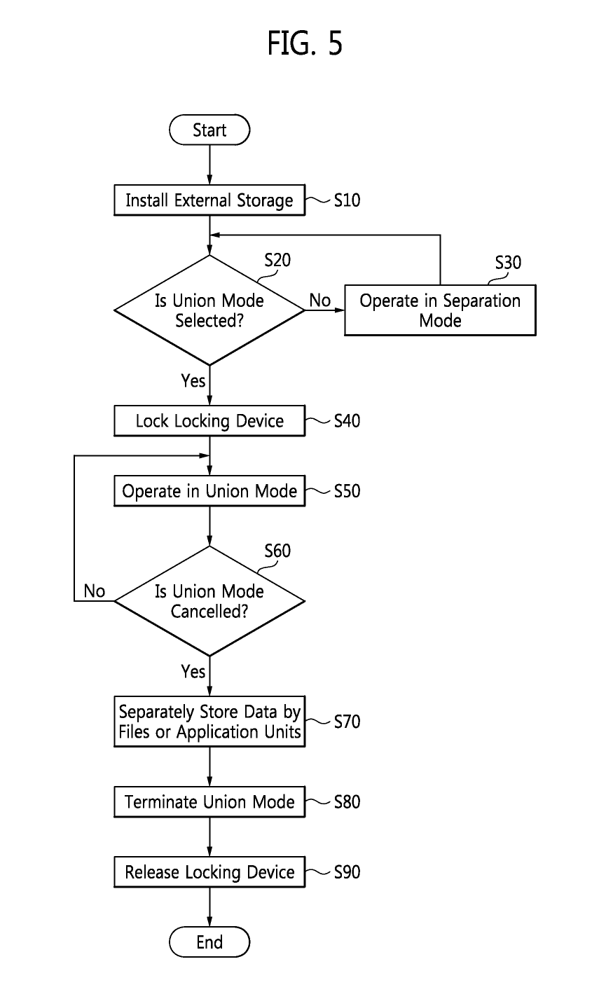

FIG. 5 is a flowchart provided to explain the union mode, in which the internal storage 20 and the external storage 50 illustrated in FIG. 1 are unified, according to an exemplary embodiment. Referring to FIGS. 1 through 5, the external storage 50 is installed at an external memory slot (not shown) which is compatible with the external storage 50 and is thus recognized by the host 100 in operation S10.

When the external storage 50 is installed at the external memory slot, a user may be allowed to select either the union mode or the separation mode through the application 110 (e.g., a device unification management application) in operation S20. When the separation mode is selected (in case of YES) in operation S20, the host 100 may recognize the internal storage 20 and the external storage 50 as independent devices and may independently perform data processing operations on the internal storage 20 and the external storage 50, respectively, in operation S30.

When the union mode is selected (in case of NO) in operation S20, the application 110 may transmit an electrical signal to a locking device (not shown) connected with the host 100. When receiving the electrical signal at a predetermined level (e.g., a high level) because the union mode is selected, the locking device may perform physical locking in operation S40 to prevent the external storage 50 from being arbitrarily detached from the external memory slot.

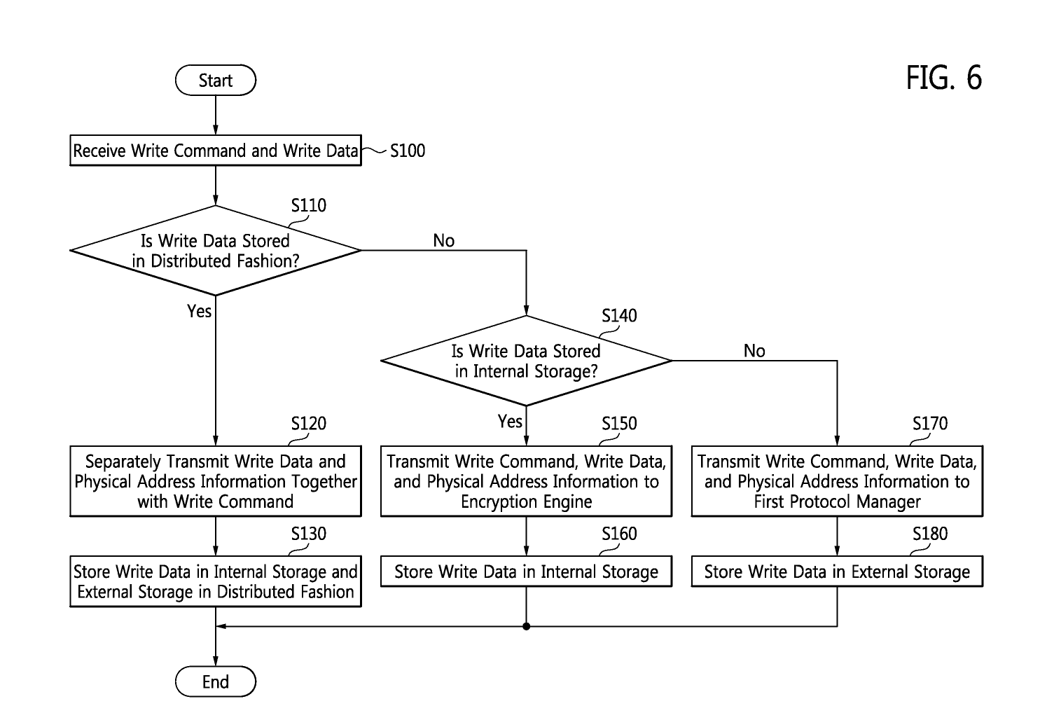

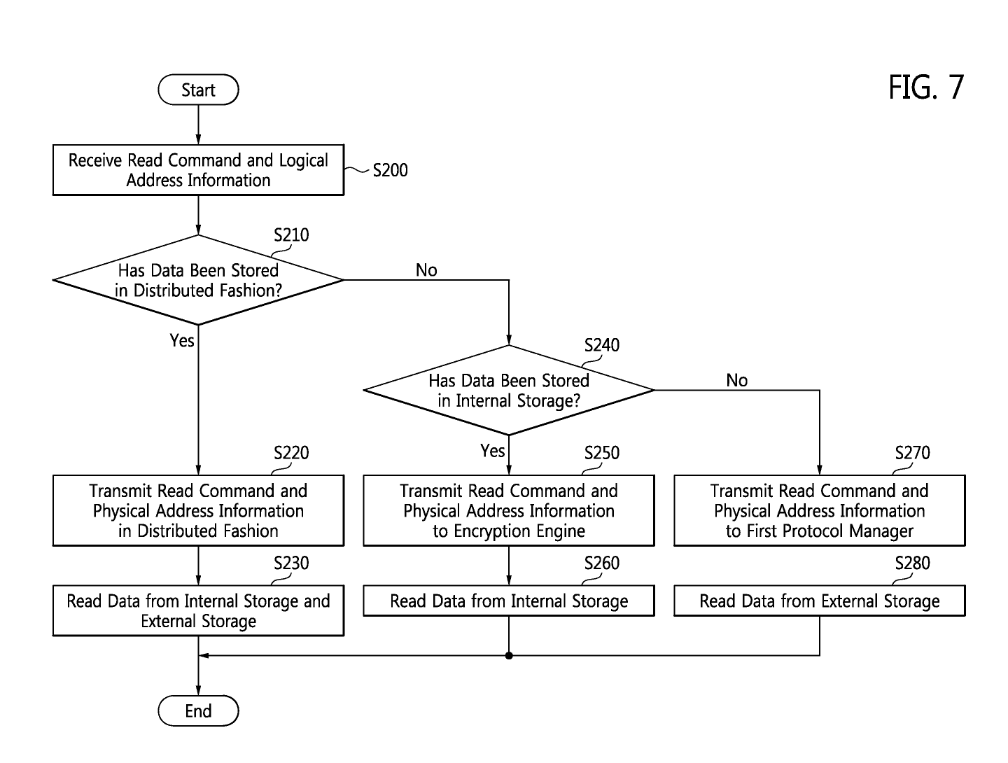

When the locking of the locking device is completed, the internal storage 20 and the external storage 50 may operate as the extended storage 10 in operation S50. Operation in the union mode will be described in detail with reference to FIGS. 6 and 7.

The application 110 may determine whether cancelling of the union mode has been requested by the user during operation in the union mode in operation S60. When the cancelling of the union mode has not been requested (in case of NO) in operation S60, the elements 20, 50, and 100 continuously operate in the union mode.

When the cancelling of the union mode has been requested (in case of YES) in operation S60, the application 110 may separately store data in the internal storage 20 and the external storage 50 by files or application types according to the user's choice in operation S70.

For instance, it is assumed that there are files A and B related to a music player application and files C and D related to a video player application and files A through D have been separately stored in the internal storage 20 and the external storage 50. When the user chooses to store files A and C in the internal storage 20 and to store files B and D in the external storage 50, the application 110 may transmit data of information for storing files A and C in the internal storage 20 and storing files B and D in the external storage 50 to the internal storage 20. The first unified storage manager 26 in the internal storage 20 may transmit a read command (or a write command) which instructs files A and C to be stored in the internal storage 20 and files B and D to be stored in the external storage 50, read data (or write data), and physical address information to the first protocol manager 25 and the encryption engine 29 using the physical address information from the first FTL 27 based on the data.

When the user chooses to store files A and B related to the music player application in the internal storage 20 and to store files C and D related to the video player application in the external storage 50, the application 110 may transmit data of information for storing files A and B in the internal storage 20 and storing files C and D in the external storage 50 to the internal storage 20. The first unified storage manager 26 in the internal storage 20 may transmit a read command (or a write command) which instructs files A and B to be stored in the internal storage 20 and files C and D to be stored in the external storage 50, read data (or write data), and physical address information to the first protocol manager 25 and the encryption engine 29 using the physical address information from the first FTL 27 based on the data.

Because the internal storage 20 and the external storage 50 are recognized by the host 100 as one extended storage 10 in the union mode, each of the files may be stored in the internal storage 20 and the external storage 50 in a distributed fashion. When the union mode is terminated in such a state or the external storage 50 is detached from the external memory slot, a file or an application which has been stored in the internal storage 20 and the external storage 50 in a distributed fashion cannot be executed normally. For this reason, the operation of storing data separately in the internal storage 20 and the external storage 50 by files or application units in operation S70 may be performed.

After the operation of separately storing data is completed, the union mode is terminated so that the extended storage 10 may enter the separation mode in operation S80. The application 110 may transmit an electrical signal to the locking device. When receiving the electrical signal at a predetermined level (e.g., a low level) because the separation mode is selected, the locking device may release the external storage 50 from the physical locking state in operation S90.

FIG. 6 is a flowchart of a write operation in the union mode illustrated in FIG. 5. Referring to FIGS. 1 through 6, the first PHY 23 may receive a write command and write data from the host 100 in operation S100. The write command and the write data may be transmitted to the first unified storage manager 26 via the first link manager 24 and the first protocol manager 25.

The first unified storage manager 26 may transmit logical address information (e.g., the size of the write data) corresponding to the write data to the first FTL 27 and may determine whether to store the write data in a distributed fashion using physical address information provided from the first FTL 27 in operation S110.

When it is determined to store the data in a distributed fashion (in case of YES) in operation S110, the first unified storage manager 26 may divide the physical address information into two portions respectively corresponding to the internal storage 20 and the external storage 50 and divide the write data into two portions respectively corresponding to the internal storage 20 and the external storage 50 and may transmit divided physical address information, divided write data, and the write command to the encryption engine 29 and the first protocol manager 25 in operation S120. At this time, the first unified storage manager 26 may transmit the portion of the write data to be stored in the external storage 50 to the encryption engine 29 first and then may transmit encoded write data to the first protocol manager 25.

The first NVM manager 30 may store one portion of the encoded write data in the first NVM 31 according to the write command and one portion of the physical address information and the second NVM manager 60 may store the other portion of the encoded write data in the second NVM 61 according to the write command and the other portion of the physical address information in operation 5130.

When it is determined to store the data in either the internal storage 20 or the external storage 50 (in case of NO) in operation S110, the first unified storage manager 26 determines whether to store the write data in the internal storage 20 in operation S140. When it is determined that the write data is to be stored in the internal storage 20 (in case of YES) in operation S140, the first unified storage manager 26 may transmit the write command, the write data, and the physical address information to the encryption engine 29 in operation S150. The first NVM manager 30 may store the encoded write data in the first NVM 31 according to the write command and the physical address information in operation 5160.

When it is determined that the write data is to be stored in the external storage 50 (in case of NO) in operation S140, the first unified storage manager 26 may transmit the write command, the write data, and the physical address information to the first protocol manager 25 in operation S170. At this time, the first unified storage manager 26 may transmit the write data to be stored in the external storage 50 to the encryption engine 29 first and then transmit the encoded write data to the first protocol manager 25. The data transmitted to the first protocol manager 25 may be transmitted to the second NVM manager 60 via the components 24, 23, 53, 54, 55, and 56. The second NVM manager 60 may store the encoded write data in the second NVM 61 according to the write command and the physical address information in operation 5180.

FIG. 7 is a flowchart of a read operation in the union mode illustrated in FIG. 5. Referring to FIGS. 1 through 7, the first PHY 23 may receive a read command and logical address information from the host 100 in operation 5200. The read command and the logical address information may be transmitted to the first unified storage manager 26 via the first link manager 24 and the first protocol manager 25.

The first unified storage manager 26 may transmit the logical address information to the first FTL 27 and may determine whether read data has been stored in a distributed fashion based on physical address information received from the first FTL 27 in operation S210. When it is determined that the read data has been stored in the internal storage 20 and the external storage 50 in a distributed fashion (in case of YES) in operation S210, the first unified storage manager 26 may divide the physical address information into two portions respectively corresponding to the internal storage 20 and the external storage 50 and transmit the two portions to the encryption engine 29 and the first protocol manager 25, respectively, together with the read command in operation 5220.

The first NVM manager 30 may read encoded data from the first NVM 31 according to the read command and the physical address information portion corresponding to the first NVM 31 and the second NVM manager 60 may read encoded data from the second NVM 61 according to the read command and the physical address information portion corresponding to the second NVM 61 in operation 5230. The first unified storage manager 26 may transmit the encoded data read from the external storage 50 to the encryption engine 29 and may transmit the read data that has been decoded to the first protocol manager 25 in operation 5230. The first unified storage manager 26 may transmit the data read from the first NVM 31 and the data read from the second NVM 61 to the host 100 via the components 25, 24, and 23 in operation 5230.

When it is determined that the read data has been stored in either the internal storage 20 or the external storage 50 (in case of NO) in operation S210, the first unified storage manager 26 may determine whether the read data has been stored in the internal storage 20 in operation 5240.

When it is determined that the read data has been stored in the internal storage 20 (in case of YES) in operation 5240, the first unified storage manager 26 may transmit the read command and the physical address information to the encryption engine 29 in operation S250. The first NVM manager 30 may read data that has been encoded from the first NVM 31 based on the read command and the physical address information in operation 5260. The read data that has been decoded by the encryption engine 29 may be transmitted to the host 100 via the components 25, 24, and 23 in operation 5260.

When it is determined that the read data has been stored in the external storage 50 (in case of NO) in operation 5240, the first unified storage manager 26 may transmit the read command and the physical address information to the first protocol manager 25 in operation 5270. The read command and the physical address information transmitted to the first protocol manager 25 may be transmitted to the second NVM manager 60 via the components 24, 23, 53, 54, 55, and 56. The second NVM manager 60 may read data that has been encoded from the second NVM 61 based on the read command and the physical address information in operation 5280. The encoded read data may be transmitted to the encryption engine 29 via the components 56, 55, 54, 53, 23, 24, 25, and 26 and the read data that has been decoded by the encryption engine 29 may be transmitted to the host 100 via the components 25, 24, and 23 in operation 5280.

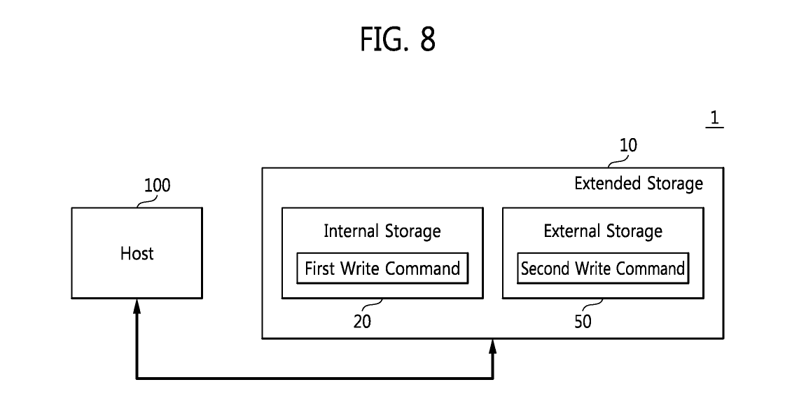

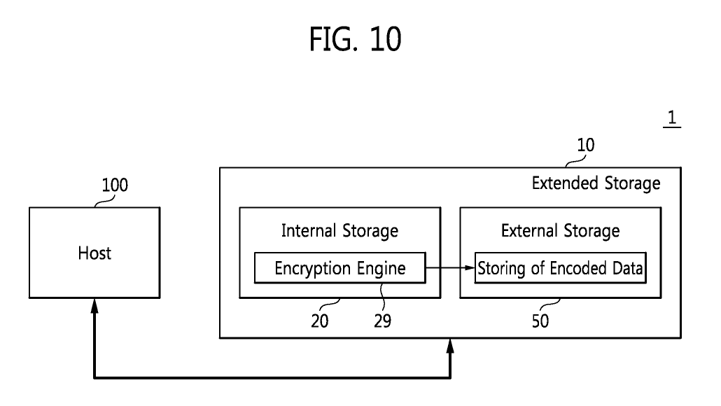

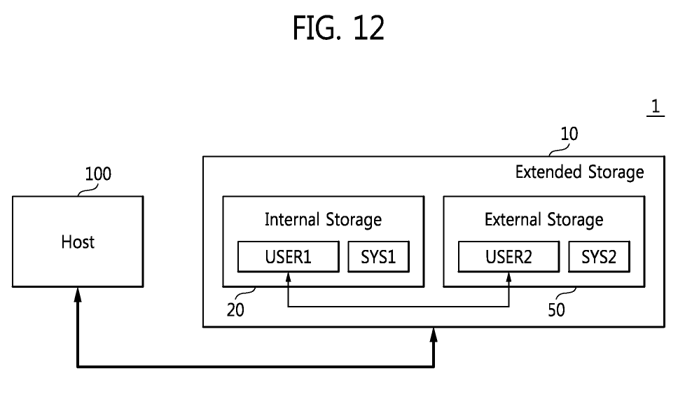

FIGS. 8, 9, 10, 11, 12 and 13 are conceptual diagrams for explaining the operations and features of the data processing system 1 illustrated in FIG. 1. Referring to FIGS. 1 through 13, blocks included in the internal storage 20 and the external storage 50 in FIGS. 8 through 13 may include a component (e.g., the encryption engine 29 illustrated in FIG. 10), data (e.g., a first write command and a second write command illustrated in FIG. 8), specified regions (e.g., a first user area and a first system area illustrated in FIG. 12), or a processing operation (e.g., storing encoded data illustrated in FIG. 10).

When the host 100 transmits a write command and write data to the extended storage 10 in the data processing system 1 illustrated in FIG. 8, the first unified storage manager 26 may determine whether to store the write data in either or both of the internal storage 20 and the external storage 50. When the first unified storage manager 26 determines to store the write data in the internal storage 20 and the external storage 50 in a distributed fashion, the internal storage 20 may execute a first write command which is a part of the write command and the external storage 50 may execute a second write command which is the remaining part of the write command. Because the internal storage 20 and the external storage 50 separately perform a write operation, a write speed is increased.

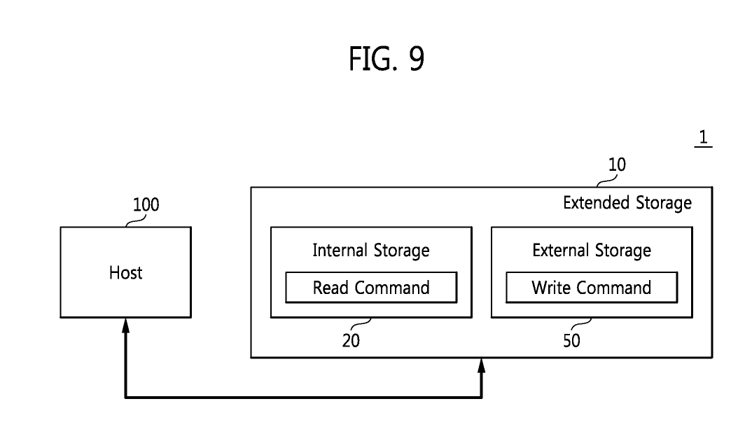

When the host 100 transmits a write command and write data to the extended storage 10 and the external storage 50 performs a write operation in the data processing system 1 illustrated in FIG. 9, a read command having higher priority than the write command may also be transmitted to the extended storage 10. At this time, when data corresponding to the read command exists in the internal storage 20, the first unified storage manager 26 may read and transmit the data to the host 100 while the external storage 50 is performing the write operation. Because the write operation of the external storage 50 and the read operation of the internal storage 20 may be performed at the same time, processing for a command having higher priority is easily performed.

When write data from the host 100 is stored in the external storage 50 in the data processing system 1 illustrated in FIG. 10, the write data may be encoded by the encryption engine 29 in the internal storage 20 and then stored in the external storage 50. Accordingly, even though the external storage 50 might be relatively weak in terms of security because the external storage 50 does not include the encryption engine 29, coding and decoding can be performed by the encryption engine 29 in the internal storage 20 for the external storage 50 in the extended storage 10, thereby increasing the security of the external storage 50.

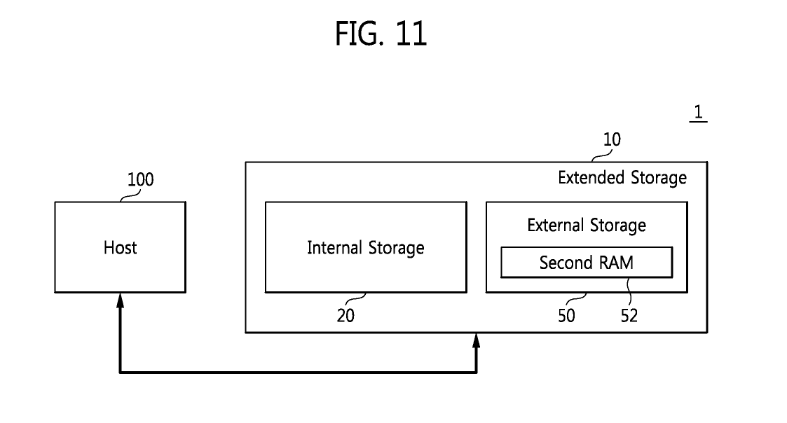

It may sometimes be difficult to store data necessary for the operation of the internal storage 20 in the internal storage 20 in the data processing system 1 illustrated in FIG. 11. For instance, when the first RAM 22 does not have enough space for the global mapping table 28, the global mapping table 28 may be stored in the second RAM 52. The global mapping table 28 stored in the second RAM 52 may be used by the first FTL 27 via the signal path illustrated in FIG. 2. At this time, the first protocol manager 25 and the second protocol manager 55 may transmit data about the global mapping table 28 stored in the second RAM 52 first before transmitting other data (e.g., read data or write data).

In this case, an access speed may be higher when the global mapping table 28 is stored in the second RAM 52 as compared to when the global mapping table 28 is stored in the first NVM 31. Accordingly, the data necessary for the operation of the internal storage 20 may be stored in the second RAM 52 in the external storage 50 when the data cannot be stored in the internal storage 20, thereby increasing a processing speed.

In the data processing system 1 illustrated in FIG. 12, the first NVM 31 may be divided into a first user area USER1 and a first system area SYS1 and the second NVM 61 may be divided into a second user area USER2 and a second system area SYS2. Each of the first and seconds system areas SYS1 and SYS2 is storage space, such as a free block used to refresh a bad block (e.g., defective block) in the first or second NVM 31 or 61, a space for maintenance of the first or second NVM 31 or 61, and a space for storing firmware, to be used for the operation of the internal storage 20 or the external storage 50. Apart from the first and second system areas SYS1 and SYS2, the first user area USER1 and the second user area USER2 are areas on which an erase operation, a read operation, or a write operation can be performed at a user's option.

The first unified storage manager 26 may manage the first user area USER1 and the first system area SYS1. For instance, when the first system area SYS1 needs to be extended at the request of the host 100 or according to the judgment of the first unified storage manager 26, the first unified storage manager 26 may extend the first system area SYS1. In detail, the first unified storage manager 26 may move some of the data stored in the first user area USER1 to the second user area USER2 and include an available space of the first user area USER1 in the first system area SYS1. More specifically, when the first unified storage manager 26 determines that the extension of the first system area SYS1 is necessary based on the request of the host 100 or based on a determination by the first unified storage manager 26, the first unified storage manager 26 may generate a read command and physical address information for some of the data in the first user area USER1 using physical address information of the first user area USER1, which has been provided from the first FTL 27, and may transmit the read command and the physical address information for some of the data to the encryption engine 29. The first unified storage manager 26 may receive data that has been read in response to the read command, may generate a write command and physical address information for the read data using physical address information of the second user area USER2 provided from the second FTL 57, and may transmit the read data, the write command, and the physical address information for the read data to the first protocol manager 25.

Only the extension of the first system area SYS1 has been described as an example, but the second system area SYS2 may also be extended. Accordingly, when extension of the system areas SYS1 and SYS2 is necessary or desired, the extension can be easily performed through data communication between the internal storage 20 and the external storage 50.

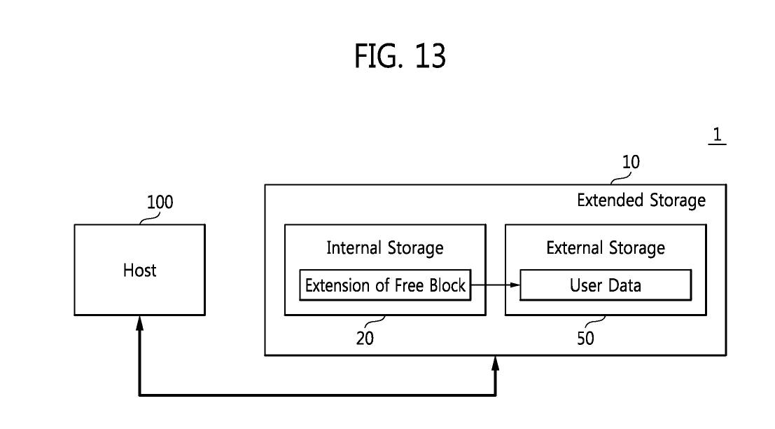

FIG. 13 shows another example of the case where the extension of the first system area SYS1 is to be used in the data processing system 1. FIG. 13 shows a case where a free block in the first system area SYS1 should be extended.

When the free block in the first system area SYS1 should be extended, the first unified storage manager 26 may move some of the data stored in the first user area USER1 to the second user area USER2 and may use the space which becomes available in the first user area USER1 due to the data movement as the free block of the first system area SYS1.

Extension of the free block in only the first system area SYS1 has been described as an example, but a free block in the second system area SYS2 may also be extended. The securing of the free block is directly related to the life of the storages 20 and 50. Accordingly, when the free block is easily secured in the storages 20 and 50, the life of the storages 20 and 50 is increased.

As described above, according to exemplary embodiments, a data processing system processes a command issued by a host in a distributed fashion, thereby increasing a data processing speed. In addition, hardware included in an internal storage or an external storage is shared by the internal and external storages in the data processing system, thereby increasing data processing performance. It is easy to extend a system area in the data processing system, so that managerial efficiency such as increasing the life of the storages is enhanced. Furthermore, encryption hardware included in the internal storage is used in common for both internal and external storages in the data processing system, so that data is encoded for the external storage as well.

While the exemplary embodiments have been particularly shown and described with reference to certain exemplary embodiments thereof, it will be understood by those of ordinary skill in the art that various changes in forms and details may be made therein without departing from the spirit and scope of the exemplary embodiments as defined by the following claims.

What is claimed is:

1. A memory controller configured to share a function of one of an internal storage and an external storage in a union mode in which the external storage and the internal storage are logically unified with each other,
wherein the memory controller is configured to translate a logical address into a physical address based on a global mapping table which maps the logical address to the physical address of each of the internal storage and the external storage and is further configured to determine which of the internal storage and the external storage processes data transmitted from a host.

2. The memory controller of claim 1, wherein, in the union mode, the memory controller is configured to control all data of a file to be stored in either of the internal storage and the external storage according to control of the host.

3. The memory controller of claim 1, wherein the memory controller is configured to store data in the internal storage and the external storage in a distributed fashion at a write request of the host.

4. The memory controller of claim 1, wherein in response to the memory controller receiving a request from the host to read data from the internal storage while the external storage is performing a write operation, the memory controller is configured to perform a read operation to read the data from the internal storage to be performed.

5. The memory controller of claim 1, wherein the memory controller is configured to collect feature information of the internal storage, provide the feature information of the internal storage to the external storage, and receive feature information of the external storage from the external storage.

6. The memory controller of claim 5, wherein:
the feature information of the internal storage and the feature information of the external storage comprise hardware feature information indicating a characteristic about hardware of the internal storage and the external storage and software feature information indicating a characteristic of software of the internal storage and the external storage;
the hardware feature information comprises at least one among a capacity of non-volatile memory, a number of non-volatile memories, a number of channels in the non-volatile memory, a size of a user area, a size of a system area, a speed of a central processing unit (CPU), a capacity of random access memory (RAM), a speed of a physical layer (PHY), and inclusion or exclusion of an encryption module; and
the software feature information comprises at least one among a version of a unified storage manager, a version of a flash translation layer (FTL), and a size of a mapping table.

7. The memory controller of claim 1, wherein the memory controller is configured to communicate with the external storage using one of a standard protocol and a nonstandard protocol.

8. The memory controller of claim 1, wherein the function is performed by a hardware component comprising a flash memory comprising a user area and a system area, and the memory controller is configured to transmit data that is stored in the user area of the flash memory to the external storage to extend the system area of the flash memory.

9. The memory controller of claim 8, wherein the extended system area is used as a free block.

10. The memory controller of claim 1, wherein the function is performed by a hardware component comprising an encryption engine configured to encode data stored in both of the internal storage and the external storage.

11. The memory controller of claim 1, wherein the function is performed by a hardware component comprising a random access memory (RAM) configured to store a global mapping table which maps a logical address to a physical address of each of the internal storage and the external storage.

12. The memory controller of claim 1, wherein the memory controller is configured to directly transmit data to the external storage.

13. The memory controller of claim 1, wherein the memory controller is configured to transmit data to the external storage via a host.

14. The memory controller of claim 1, wherein the memory controller is configured to transmit data to the external storage via an arbiter configured to relay the data.

15. The memory controller of claim 1, wherein the memory controller is implemented in the internal storage.

16. The memory controller of claim 1, wherein the memory controller is implemented in the external storage.

17. A data processing system comprising:
an external storage provided external to an electronic device;
an internal storage included in the electronic device; and
a memory controller configured to share a function of one of the internal storage and the external storage in a union mode in which the external storage and the internal storage are logically unified with each other,
wherein the function is performed by a hardware component which is one selected from an encryption engine, a random access memory (RAM), and a flash memory.

18. An electronic device, comprising:
a first nonvolatile memory installed in the electronic device; and
a memory controller configured to enable a functionality of the first nonvolatile memory to be shared among a second nonvolatile memory for reading data from or writing data to the first nonvolatile memory and the second nonvolatile memory using the functionality,
wherein the second nonvolatile memory is configured to be inserted into the electronic device, and
wherein the functionality comprises at least one of encrypting and encoding the data.

19. The electronic device of claim 18, wherein the functionality is shared among the second memory by logically unifying the first memory and the second memory and distributing the data among the logically unified first memory and the second memory.
